(19) United States
(12) Patent Application Publication
(10) Pub. No.: US 2022/0369597 A1
(43) Pub. Date: Nov. 24, 2022

(54) Shoulder Strap Type Electronic Cooling Equipment for Pets

(71) Applicant: Menarde LLC, Houston, TX (US)

(72) Inventor: CHAOCHENG QIU, Houston, TX (US)

(21) Appl. No.: 17/326,393

(22) Filed: May 21, 2021

(51) Int. Cl. A01K 27/00; A01K 13/00

(52) U.S. Cl. CPC A01K 27/006; A01K 13/006

(57) ABSTRACT

The disclosure provides shoulder strap type electronic cooling equipment for pets. The shoulder strap type electronic cooling equipment comprises a shoulder strap worn on the back of the pet, wherein an elastic adjustment band and a fan mechanism are arranged on one side of the shoulder strap; and when the pet wears the shoulder strap, the fan mechanism can be freely adjusted in a head and neck area of the pet, and the fan mechanism can supply air to cool the pet. The disclosure has the beneficial effects that in the shoulder strap type electronic cooling equipment for the pets, the fans with freely-adjustable angles are arranged on the traditional shoulder strap, so that the head and the torso of the pet can be cooled, and the phenomenon of heatstroke is avoided in hot weather; meanwhile, the LED lamps are further arranged, and the LED lamps can emit light when the fans are running, so that a user can confirm the position of the pet through the always-on or flashing LED lamps while walking the pet; and therefore, not only can the pet be cooled, but also the technical effect that the pet is not easy to lose is realized.

### TECHNICAL FIELD

The disclosure relates to the technical field of pet supplies, in particular to shoulder strap type electronic cooling equipment for pets.

### BACKGROUND

Pet bands are made of imported nylon material, with bright colors and excellent hand feeling. According to characteristics of the various pets, woven bands of various specifications and colors can be produced, meanwhile special colors and jacquard can be achieved, and heat transfer printing, softening treatment and the like can be conducted; or finished pet bands can be processed and assembled according to customer requirements, the safety pet bands including safety pet collars, dog chains, dog shoulder straps, dog leashes, cat collars, cat leashes and cat back and chest straps.

Shoulder straps for pets in the prior art only play a role in traction, have a single function, and cannot meet multi-functional requirements of the market for the shoulder straps for the pets, which affects the market competitiveness of the shoulder straps for the pets. When people walking a dog in summer, the pet has thick hair and does not dissipate heat well, so that the phenomenon of heatstroke may occur in hot weather. Therefore, the shoulder strap type electronic cooling equipment for the pets is proposed.

### SUMMARY

In view of shortcomings of the prior art, the disclosure provides shoulder strap type electronic cooling equipment for pets, which has the advantages of cooling and heat dissipation, easy disassembly and assembly, etc., and solves the problem that when people are walking a dog in summer, the pet has thick hair and does not dissipate heat well, so that the phenomenon of heatstroke may occur in hot weather.

In order to achieve the above purpose, the disclosure adopts the technical scheme as follows:

the shoulder strap type electronic cooling equipment for the pets comprises a shoulder strap worn on the back of the pet, wherein an elastic adjustment band and a fan mechanism are arranged on one side of the shoulder strap; and when the pet wears the shoulder strap, the fan mechanism can be freely adjusted in a head and neck area of the pet, and the fan mechanism can supply air to cool the pet.

Preferably, a clamping piece and a buckling piece are arranged at two ends of the elastic adjustment band correspondingly, and after the pet wears the shoulder strap, the clamping piece is movably connected with the buckling piece.

Preferably, the fan mechanism comprises a U-shaped support, adjustment rods and fan bodies, wherein one end of each adjustment rod is connected to the U-shaped support, and the other end is connected to the fan body; the adjustment rods are flexible metal tubes and angles of the adjustment rods can be freely adjusted; and each fan body is composed of a protective net cover, fan blades and a rotary motor. The fan blades and the rotary motor are fixedly connected into the protective net cover.

Preferably, a flexible silica gel tube is further arranged on the surface of each flexible metal tube. After the pet wears the shoulder strap, the fan bodies can supply the air to a specified area of the pet by adjusting the directions of the flexible silica gel tube.

Preferably, LED lamp heads are fixedly installed on the protective net cover.

Preferably, the LED lamp heads have a plurality of colors, as well as an always-on mode or a flashing mode.

The disclosure has the beneficial effects that in the shoulder strap type electronic cooling equipment for the pets, the fans with freely-adjustable angles are arranged on the traditional shoulder strap, so that the head and the torso of the pet can be cooled, and the phenomenon of heatstroke is avoided in hot weather; meanwhile, the LED lamps are further arranged, and the LED lamps can emit light when the fans are running, so that a user can confirm the position of the pet through the always-on or flashing LED lamps while walking the pet; and therefore, not only can the pet be cooled, but also the technical effect that the pet is not easy to lose is realized.

### BRIEF DESCRIPTION OF THE DRAWINGS

FIG. 1 is a schematic diagram of a structure of the disclosure.

### DETAILED DESCRIPTION OF THE EMBODIMENTS

The disclosure will be further described in combination with drawings. It should be noted that this embodiment, based on the technical scheme as a prerequisite, provides detailed implementation and specific operation procedures, but the protection scope of the disclosure is not limited to this embodiment.

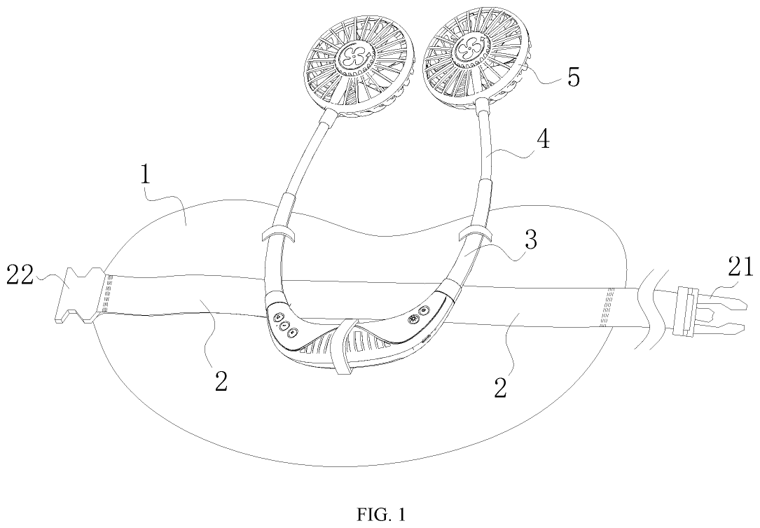

As shown in FIG. 1, in the disclosure, the shoulder strap type electronic cooling equipment for the pets comprises a shoulder strap 1 worn on the back of the pet, wherein an elastic adjustment band 2 and a fan mechanism are arranged on one side of the shoulder strap 1; and when the pet wears the shoulder strap 1, the fan mechanism can be freely adjusted in a head and neck area of the pet, and the fan mechanism can supply air to cool the pet.

As shown in FIG. 1, a clamping piece 21 and a buckling piece 22 are arranged at two ends of the elastic adjustment band 2 correspondingly, and after the pet wears the shoulder strap 1, the clamping piece 21 is movably connected with the buckling piece 22. Therefore, the elastic adjustment band can be worn by the pets of different body types.

Furthermore, as shown in FIG. 1, the fan mechanism comprises a U-shaped support 3, adjustment rods 4 and fan bodies 5, wherein one end of each adjustment rod 4 is connected to the U-shaped support 3, and the other end is connected to the fan body 5; the adjustment rods 4 are flexible metal tubes and angles of the adjustment rods can be freely adjusted; and each fan body 5 is composed of a protective net cover, fan blades and a rotary motor. The fan blades and the rotary motor are fixedly connected into the protective net cover.

Furthermore, in order to protect the pet's hair from being drawn into the fan bodies, the fan bodies can be replaced with turbo fans.

It should be noted that a controller circuit and a switch of the fan mechanism are both integrated into the U-shaped support.

It should be further noted that in order to protect the flexible metal tube, a layer of flexible silica gel tube can be wrapped on the surface of the flexible metal tube. After the pet wears the shoulder strap, the fan bodies can supply the air to a specified area of the pet by adjusting the directions of the flexible silica gel tube.

In order to find the pet at night, LED lamp heads are fixedly installed on the protective net cover. When the disclosure starts, the LED lamp heads can be turned on.

Furthermore, the LED lamp heads have a plurality of colors, as well as an always-on mode or a flashing mode.

### Embodiment

When in use, the disclosure is worn by the pet after the elastic band is adjusted, and then the positions of the flexible metal tubes are adjusted, so that the fan bodies are located at a proper position of the pet. The air can be supplied for cooling by turning the power on; in addition, under the condition that the turbo fans are used, installation space is saved, and meanwhile it ensures that the pet's hair is prevented from being easily drawn into the fans; in addition, the LED lamps are also arranged on the protective net cover of the fan bodies, so that the user can locate and find the pet even in dark places.

For those skilled in the art, various corresponding variations and modifications can be given based on the above technical scheme and concepts, and all these variations and modifications should be within the protection scope of the claims of the disclosure.

1. Shoulder strap type electronic cooling equipment for pets, the shoulder strap type electronic cooling equipment comprising a shoulder strap worn on the back of the pet, wherein an elastic adjustment band and a fan mechanism are arranged on one side of the shoulder strap; and when the pet wears the shoulder strap, the fan mechanism can be freely adjusted in a head and neck area of the pet, and the fan mechanism can supply air to cool the pet.

2. The shoulder strap type electronic cooling equipment for the pets according to claim 1, wherein a clamping piece and a buckling piece are arranged at two ends of the elastic adjustment band correspondingly, and after the pet wears the shoulder strap, the clamping piece is movably connected with the buckling piece.

3. The shoulder strap type electronic cooling equipment for the pets according to claim 1, wherein the fan mechanism comprises a U-shaped support, adjustment rods and fan bodies; one end of each adjustment rod is connected to the U-shaped support, and the other end is connected to the fan body; the adjustment rods are flexible metal tubes and angles of the adjustment rods can be freely adjusted; and each fan body is composed of a protective net cover, fan blades and a rotary motor, and the fan blades and the rotary motor are fixedly connected into the protective net cover.

4. The shoulder strap type electronic cooling equipment for the pets according to claim 3, wherein a flexible silica gel tube is further arranged on the surface of each flexible metal tube; and after the pet wears the shoulder strap, the fan bodies can supply the air to a specified area of the pet by adjusting the directions of the flexible silica gel tube.

5. The shoulder strap type electronic cooling equipment for the pets according to claim 3, wherein LED lamp heads are fixedly installed on the protective net cover.

6. The shoulder strap type electronic cooling equipment for the pets according to claim 5, wherein the LED lamp heads have a plurality of colors, as well as an always-on mode or a flashing mode.
